(19) United States
(12) Patent Application Publication
(10) Pub. No.: US 2010/0193469 A1
(43) Pub. Date: Aug. 5, 2010

(54) METHOD FOR MANUFACTURING MICRO/NANO THREE-DIMENSIONAL STRUCTURE

(75) Inventors: Yung-Chun LEE, TAINAN CITY (TW); Chun-Hung CHEN, TAINAN CITY (TW); Te-Hui YU, TAINAN CITY (TW)

Correspondence Address: BRIAN M. MCINNIS, 12th Floor, Ruttonjee House, 11 Duddell Street, Hong Kong, HK

(73) Assignee: NATIONAL CHENG KUNG UNIVERSITY, TAINAN CITY (TW)

(21) Appl. No.: 12/699,892

(22) Filed: Feb. 4, 2010

(30) Foreign Application Priority Data
Feb. 5, 2009 (TW) 98103727
Sep. 8, 2009 (TW) 98130260

(51) Int. Cl. B44C 1/22

(52) U.S. Cl. 216/49; 216/52; 216/41; 216/51

(57) ABSTRACT

A method for manufacturing a micro/nano three-dimensional structure including the following steps is described. A mold is provided, and a pattern structure including a plurality of convex portions and concave portions is set in the mold. A transfer material layer including a first portion on the convex portions and a second portion on the concave portions is formed. A flexible substrate is disposed on the mold and contacts with the first portion of the transfer material layer. A heating step is performed to partially heat the flexible substrate through the first portion. A pressure is applied on the flexible substrate to adhere or press the first portion to the flexible substrate. The mold is removed. An etching step is performed on the flexible substrate by using the first portion of the transfer material layer as a mask to form a micro/nano three-dimensional structure in the flexible substrate.

### RELATED APPLICATIONS

This application claims priority to Taiwan Application Serial Number 98103727, filed Feb. 5, 2009, and Taiwan Application Serial Number 98130260, filed Sep. 8, 2009, which is herein incorporated by reference.

### FIELD OF THE INVENTION

The present invention relates to a micro/nano printing process, and more particularly to a method for manufacturing a micro/nano three-dimensional structure by a micro/nano printing technique.

### BACKGROUND OF THE INVENTION

As the increasingly reducing of the sizes of electronic devices, the pattern definition of the electronic devices is confronted with an ordeal. In the current electronic device processes, an optical lithography technique is typically used to define the feature patterns of the device. However, due to the optical diffraction limit, the size of the pattern feature, which the optical lithography technique can define, can also be seriously limited.

In accordance with this, a micro/nano-imprinting technology, which has been developed currently, has been regarded as one possible method that can surpass and replace the conventional micro/nano optical lithography technology. Among the developed imprint techniques, the contact micro/nano pattern imprinting technique is a common imprinting technique currently. In the contact micro/nano pattern imprinting technique, a transfer material layer is disposed on a pattern structure of a mold. Next, a substrate and the pattern structure of the mold are oppositely pressed to connect the transfer material layer on convex portions of the pattern structure and a surface of the substrate. Then, the transfer material layer is heated to increase the adhesion between the transfer material layer on the convex portions of the mold and the surface of the substrate. Subsequently, the mold is removed. Therefore, the transfer material layer on the convex portions of the pattern structure on the mold can be transferred onto the surface of the substrate to complete the imprinting of the micro/nano pattern.

However, when the size of the transferring pattern is increasingly reduced to the micro/nano scale, the uniformity, the precision and the reliability of the pattern transferring are greatly reduced by the altitude difference between the convex portions of the pattern structure. Particularly, in the process of forming a micro/nano pattern on a flexible substrate, the thermal deformation of the flexible substrate due to the temperature or the damage of substrate caused by the development and chemical etching process in the optical lithograph process of the flexible substrate need to be overcome.

Therefore, a novel and simple micro/nano pattern transferring technique is needed to overcome the negative influences on the uniformity, the precision and the reliability of the pattern transferring process due to the altitude difference in a pattern structure of a mold, and to prevent the thermal deformation due to the temperature or the damage of the substrate caused by the developing and chemical etching in the forming of the macro/nano pattern on the flexible substrate from occurring.

### SUMMARY OF THE INVENTION

Therefore, one aspect of the present invention is to provide a method for manufacturing a micro/nano three-dimensional structure, which can transfer a transfer layer including a micro/nano pattern onto a flexible substrate by a directly contact printing technique, and can use the transfer layer as a mask to etch the flexible substrate to successfully form a micro/nano three-dimensional structure on the flexible substrate.

Another aspect of the present invention is to provide a method for manufacturing a micro/nano three-dimensional structure, which can use a transfer layer transferred onto a flexible substrate as an etching mask to remove the portion, which is not covered by the transfer layer, to form a mask. The mask can be used as a mask in an electron beam lithography or a mask used to form a micro/nano pattern by a vapor deposition method.

Still another aspect of the present invention is to provide a method for manufacturing a micro/nano three-dimensional structure. The method can use a roll-printing method or a method of applying a uniform pressure to a mold to a flexible substrate, so that the problems of altitude difference and uniformity that may occur between the mold and a contact surface of the flexible substrate can be effectively solved, thereby increasing the reliability of the printing process. Therefore, the micro/nano pattern can be successfully transferred onto the flexible substrate by a printing process.

Further another aspect of the present invention is to provide a method for manufacturing a micro/nano three-dimensional structure, which can successfully form another transfer layer in concave portions of a three-dimensional of a flexible substrate by lifting-off a transfer layer. Therefore, convex portions of the three-dimensional can be removed by using the another transfer layer as an etching mask, so that a micro/nano three-dimensional structure with a pattern complementary to a pattern of a mold can be successfully formed.

Yet another aspect of the present invention is to provide a method for manufacturing a micro/nano three-dimensional structure. The method performs a partially contacting and heating step on a flexible substrate, so that the thermal deformation of the flexible substrate due to the temperature can be effectively solved, and the micro/nano pattern can be successfully transferred onto the flexible substrate by a printing process.

According to the aforementioned aspects, the present invention provides a method for manufacturing a micro/nano three-dimensional structure including the following steps. A mold including a first surface and a second surface on opposite sides is provided, wherein a pattern structure including a plurality of convex portions and a plurality of concave portions is set in the first surface. An anti-stick layer may be selectively formed on the first surface of the mold according to the strength of the anti-stickiness of the surface of the mold. A transfer material layer including a first portion on the convex portions and a second portion on the concave portions is formed. A flexible substrate including a first surface and a second surface is disposed on the mold, wherein the first surface of the flexible substrate contacts with the first portion of the transfer material layer. A heating step is performed on the second surface of the mold to partially heat the flexible substrate through the first portion of the transfer material layer. A pressure is applied on the second surface of the flexible substrate to make the first portion of the transfer material layer be adhered to or be pressed into the first surface of the flexible substrate. The mold is removed. An etching step is performed on the flexible substrate by using the first portion of the transfer material layer as a mask to form a first micro/nano three-dimensional structure in the first surface of the flexible substrate.

According to a preferred embodiment of the present invention, after the etching step, the method for manufacturing a micro/nano three-dimensional structure further includes the following steps. A mask layer is formed, wherein the mask layer includes a first portion on the first portion of the transfer material layer and a second portion on a plurality of concave portions of the first micro/nano three-dimensional structure. A lift-off step is performed to remove the first portion of the transfer material layer and the first portion of the mask layer. Another etching step is performed by using the second portion of the mask layer as a mask to remove the flexible substrate, which is not covered by the mask layer, to form a second micro/nano three-dimensional structure.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIGS. 1 through 7 are schematic flow diagrams showing a process for manufacturing a micro/nano three-dimensional structure in accordance with an embodiment of the present invention;

FIG. 8 illustrates a cross-sectional view of a micro/nano three-dimensional structure in accordance with another embodiment of the present invention;

FIG. 9 illustrates a cross-sectional view of a micro/nano three-dimensional structure in accordance with still another embodiment of the present invention;

FIG. 10 illustrates a cross-sectional view of a micro/nano three-dimensional structure in accordance with further another embodiment of the present invention;

FIGS. 11 through 13 are schematic flow diagrams showing a process for manufacturing a micro/nano three-dimensional structure in accordance with yet another embodiment of the present invention; and

FIG. 14 illustrates a cross-sectional view of a micro/nano three-dimensional structure in accordance with still further another embodiment of the present invention.

### DETAILED DESCRIPTION OF THE PREFERRED EMBODIMENT

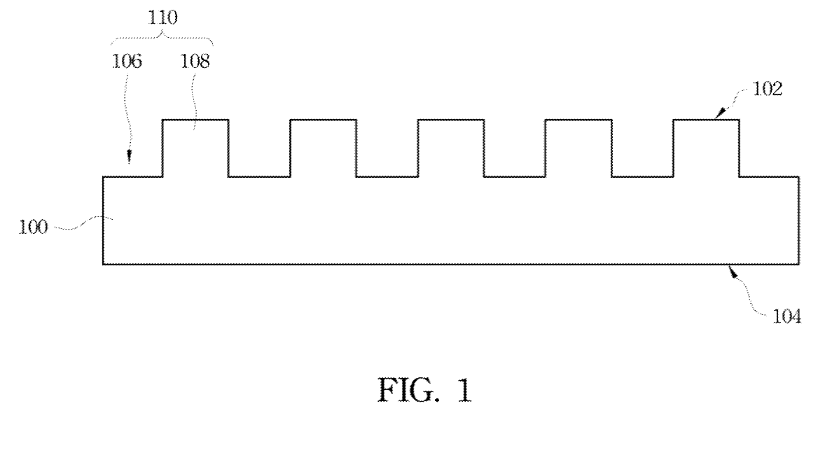

Refer to FIGS. 1 through 7. FIGS. 1 through 7 are schematic flow diagrams showing a process for manufacturing a micro/nano three-dimensional structure in accordance with an embodiment of the present invention. In the present embodiment, in the manufacturing of a micro/nano three-dimensional structure, a mold 100 for printing may be firstly provided, wherein the mold 100 includes surfaces 102 and 104 on opposite sides. Such as shown in FIG. 1, a pattern structure 110 of printing is preset on the surface 102 of the mold 100, wherein the pattern structure 110 includes a plurality of convex portions 108 and a plurality of concave portions 106. In the present invention, the feature size of the pattern structure 110 may be preferably in a micrometer scale or a nanometer scale. In one embodiment, the material of the mold 100 may be silicon (Si), a polymer-based material, an organic material, a plastic material, a semiconductor material, a metal material, quartz, a glass material, a ceramic material, an inorganic material, or a compound composed of any two or more of the aforementioned materials.

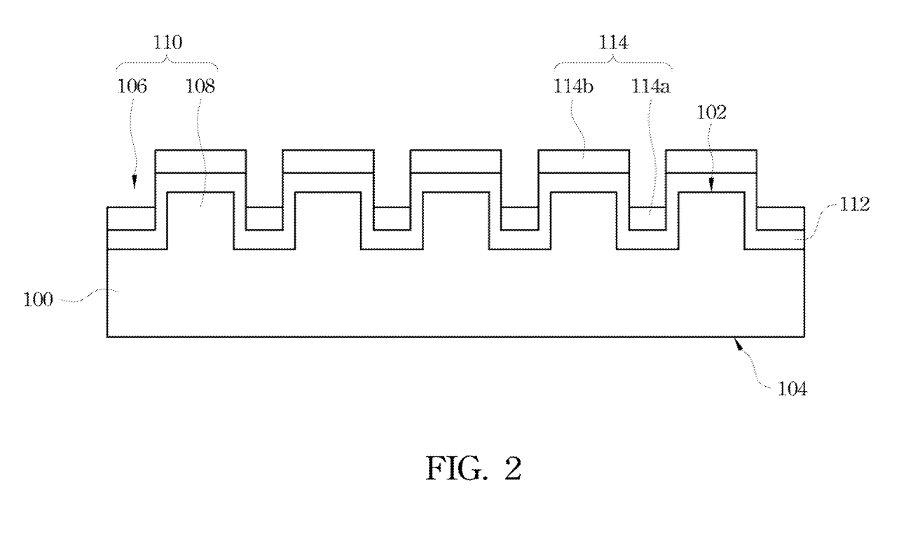

Next, such as shown in FIG. 2, an anti-stick layer 112 is selectively formed to conformally cover the pattern structure 110 of the mold 100 by, for example, a thermal evaporation method. In another embodiment, when the material of the mold 100 itself has an anti-stick property, such as a fluorine-containing polymer-based material with an anti-stick effect, the anti-stick layer 112 do not need additionally to form on the surface 102 of the mold 100. In the another embodiment, the material of the mold 100 may be metal, an inorganic material, a polymer-based material, a ceramic material, a semiconductor material or an organic material with an anti-stick effect, or a compound composed of any two or more of the aforementioned materials. In one example, the fluorine-containing polymer-based material with the anti-stick effect may be ethylene tetrafluoroethylene, such as ethylene tetrafluoroethylene produced by the DuPont Company.

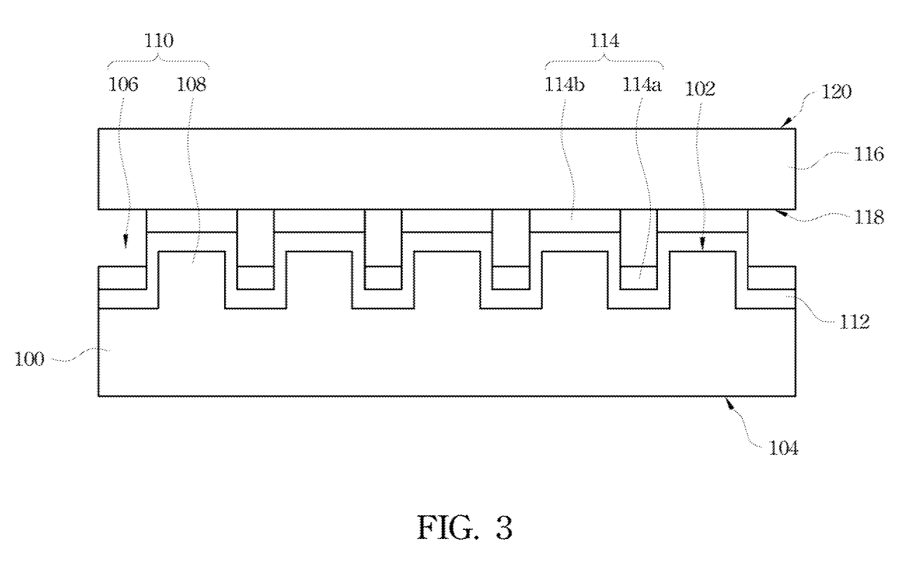

Then, a transfer material layer 114 is formed on the anti-stick layer 112 by, for example, a thermal evaporation method or an electron beam evaporation method, or a chemical vapor deposition method or a physical vapor deposition method cooperating with a typical pattern definition technique. Such as shown in FIG. 2, the transfer material layer includes two portions 114a and 114b, wherein the portion 114a of the transfer material layer 114 covers the anti-stick layer 112 in the concave portions 106 of the pattern structure 110, and the portion 114b of the transfer material layer 114 covers the anti-stick layer 112 on the top surfaces of the convex portions 108 of the pattern structure 110. In some embodiments, when the material of the mold 100 itself has the anti-stick property, the transfer material layer 114 can directly cover the pattern structure 110 of the mold 100, wherein the portion 114a of the transfer material layer 114 directly covers the bottom surfaces of the concave portions 106 of the pattern structure 110, and the other portion 114b of the transfer material layer 114 directly covers the top surfaces of the convex portions 108 of the pattern structure 110. A higher etch selectivity is between the material of the transfer material layer 114 and a flexible substrate 116 (referring to FIG. 3) provided subsequently. The material of the transfer material layer 114 may typically be an inorganic material, a ceramic material, a metal material, a polymer-based material, an organic material, a plastic material, a semiconductor material, or a compound composed of any combinations of the aforementioned materials. In one embodiment, the material of the transfer material layer 114 may be metal, such as chromium (Cr).

By disposing the anti-stick layer 112, or by using the mold 100 composed of the material having the anti-stick property, the portion 114b of the transfer material layer 114 on the convex portions 108 of the mold 100 can successfully be separated from the convex portions 108 of the mold 100 during the subsequent printing process.

Next, a flexible substrate 116 may be provided, wherein the flexible substrate 116 includes surfaces 118 and 120 on opposite sides. In one embodiment, the material of the flexible substrate 116 may be, for example, an organic material, a plastic material, a polymer material, or a compound composed of any two or more of the aforementioned materials. In one exemplary embodiment, the material of the flexible substrate 116 may be, for example, polyethylene terephthalate (PET). Then, referring to FIG. 3, the flexible substrate 116 is disposed on the surface 102 of the mold 100, the surface 118 of the flexible substrate 116 is opposite to the surface 102 of the mold 100, and the surface 118 of the flexible substrate 116 contacts the portion 114b of the transfer material layer 114 on the convex portions 108 of the pattern structure 110 of the mold 100.

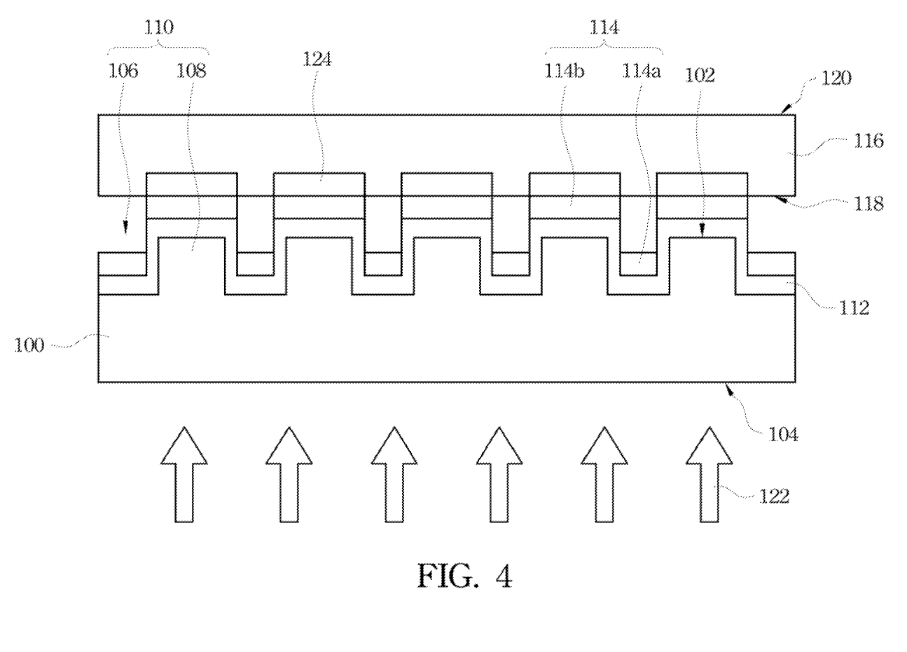

Subsequently, referring to FIG. 4, a heat source 122 is provided and is used to perform a heating step from the surface 104 of the mold 100. In the heating step, the mold 100 is heated from the surface 104 of the mold 100 by the heat source 122, and the portion 114b of the transfer material layer 114 on the convex portions 108 on the other surface 102 of the mold 100 is heated through the thermal conduction effect and the thermal radiation effect. The portion of the surface 118 of the flexible substrate 116 contacting with the heated portion 114b of the transfer material layer 114 is further heated by the heated portion 114b. Thus, the flexible substrate 116 can be partially heated to form a heated portion 124 on the local region of the flexible substrate 116 contacting with the portion 114b of the transfer material layer 114. In one exemplary embodiment, the heating step includes controlling the heating temperature to heat the heated portion 124 of the flexible substrate 116 contacting with the portion 114b of the transfer material layer 114 on the convex portions 108 of the mold 100 to a glass transition temperature (Tg) melting state, to prevent or eliminate the portion of the flexible substrate 116 beyond the heated portion 124 from being softened and melting, and to soften the heated portion 124 of the flexible substrate 116. Therefore, the portion 114b of the transfer material layer 114 pressed on the heated portion 124 of the flexible substrate 116 can be adhered to or pressed into the softened, melting heated portion 124 of the flexible substrate 116. In some embodiments, the heat source 122 used in the heating step may be, for example, a radiation heat source, a lamp-illuminating heat source, a thermal resistor heat source, an eddy current heat source, a microwave-heating heat source or an ultrasound-heating heat source.

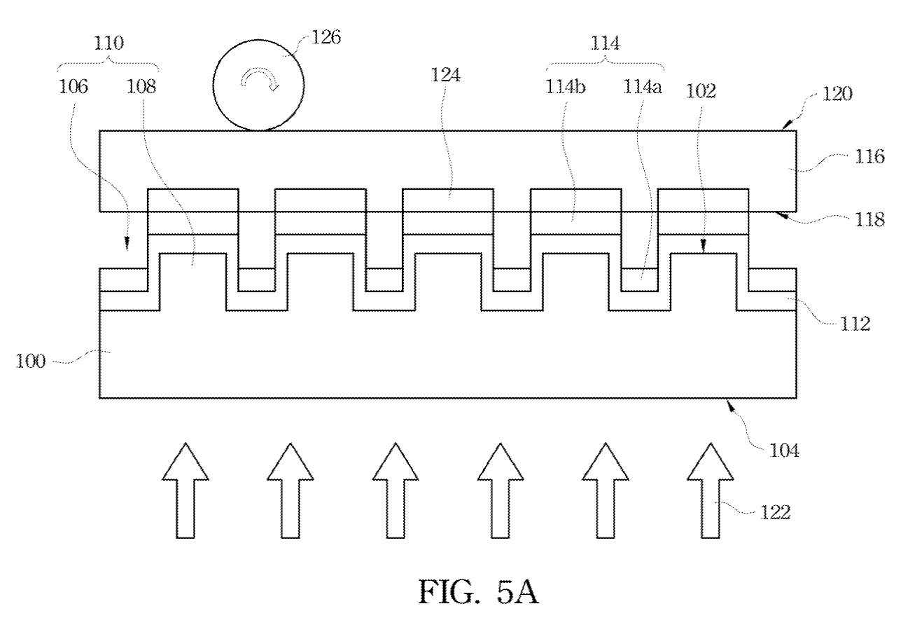

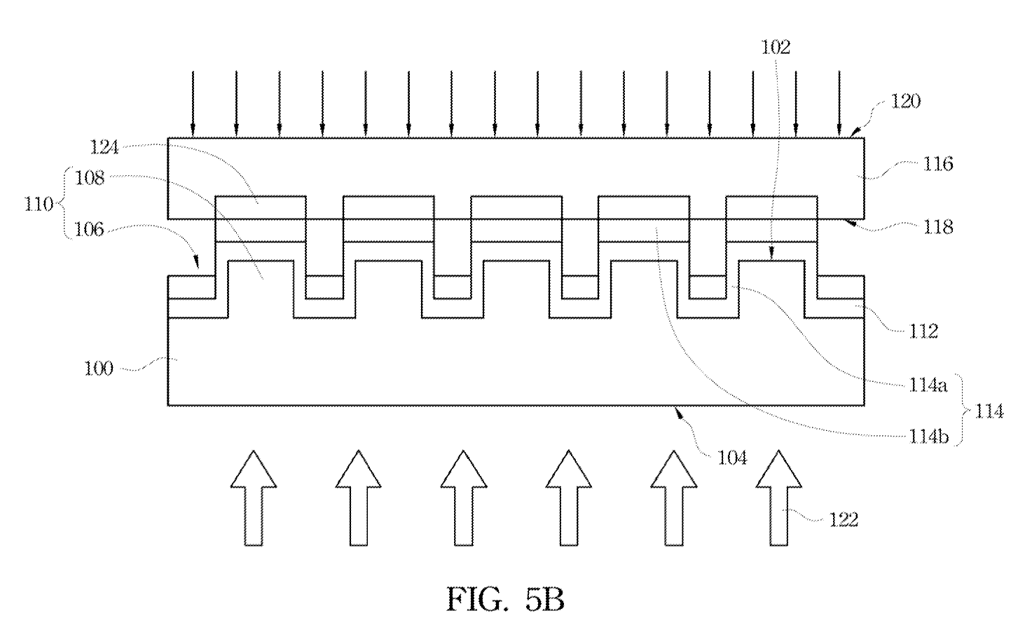

In one embodiment, such as shown in FIG. 5A, when the flexible substrate 116 is partially heated, a roller 126 may be provided. The roller 126 is disposed on the surface 120 of the flexible substrate 116 to press the flexible substrate 116 from the surface 120 of the flexible substrate 116. The material of the roller 126 may be transparent or opaque. The material of the roller 126 may be, for example, glass, metal, a plastic material, a polymer-based material, an inorganic material, a ceramic material, a semiconductor material, an organic material or a compound composed of any combinations of the aforementioned materials.

Referring to FIG. 5A, a roll-printing step is performed on the surface 120 of the flexible substrate 116 by using the roller 126, so that the portion 114b of the transfer material layer 114 on all convex portions 108 of the pattern structure 110 of the mold 100 can further completely and closely contact with the surface 118 of the flexible substrate 116.

In another embodiment, such as shown in FIG. 5B, a uniform pressure, such as an air pressure, may be applied on the flexible substrate from the surface 120 of the flexible substrate 116. Therefore, the portion 114b of the transfer material layer 114 on all convex portions 108 of the pattern structure 110 of the mold 100 can further completely and closely contact with the surface 118 of the flexible substrate 116 similarly.

At this time, the heated portion 124 of the flexible substrate 116 has been softened and melted, so that the portion 114b of the transfer material layer 114 on all convex portions 108 can be completely transferred onto the surface 118 of the flexible substrate 116 after the roll-printing step or applying the uniform pressure. Therefore, by performing the roll-printing step or by applying the uniform pressure, the problems of altitude difference and uniformity that may occur between the portion 114b of the transfer material layer 114 on the convex portions 108 of the mold 100 and the contact surface of the flexible substrate 116 can be effectively solved, and the deficient flatness of the contact surface can be supplemented, thereby increasing the reliability of the imprinting process.

In one exemplary embodiment, the material of the mold 100 may be, for example, silicon, the material of the flexible substrate 116 may be, for example, polyethylene terephthalate (PET), and the heat source 122 used in the heating step may be, for example, an infrared heat lamp. The infrared has high transparence to the mold 100 composed of silicon, so that in addition to the indirect heating through the thermal conduction, the infrared can directly heat the transfer material layer 114 on the other surface 102 of the mold 100. As a result, the energy provided by the heat source 122 can be effectively transmitted to enhance the process efficiency. In the exemplary embodiment, the heating temperature of the heating step may be controlled between substantially 80° C. and substantially 300° C., to mainly heat the portion of the flexible substrate 116 contacting with the transfer material layer 114 to a thermal melting state.

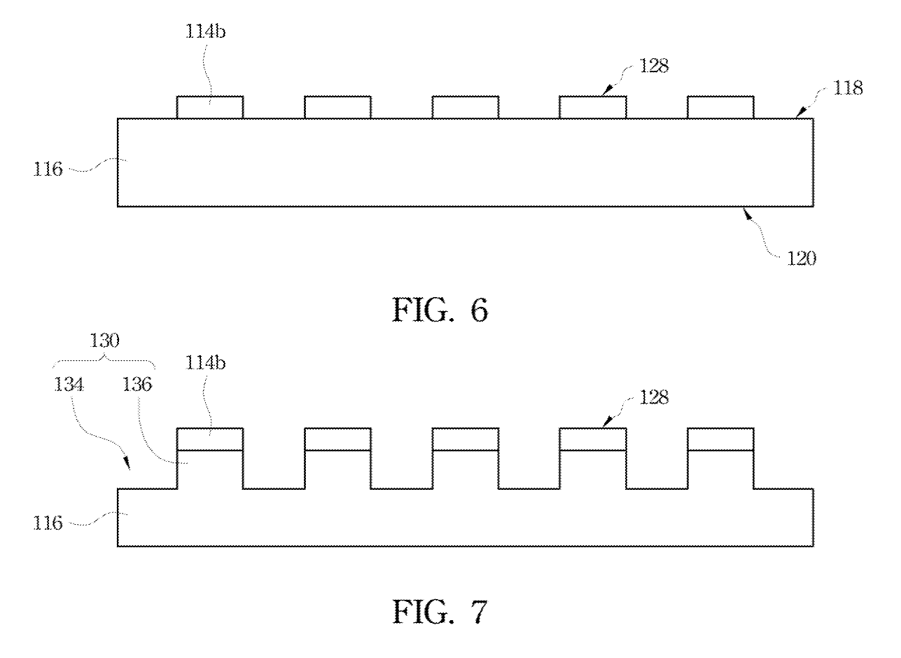

Subsequently, the roller 126 or the applying of the uniform pressure is removed from the surface 120 of the flexible substrate 116, and then the mold 100 is separated from the flexible substrate 116. The anti-stick layer 112 is disposed between the mold 100 and the transfer material layer 114, or the material of the mold 100 itself has the anti-stick property, and the portion 114b of the transfer material layer 114 on the convex portions 108 of the pattern structure 110 of the mold 100 is adhered or pressed into the partially softened, melting heated portion 124 of the flexible substrate 116, so that the portion 114b of the transfer material layer 114 on the convex portions 108 of the mold 100 can successfully come off the convex portions 108 of the mold 100 and is successfully printed or pressed onto the surface 118 of the flexible substrate 116, so as to form a printed micro/nano pattern structure 128, such as shown in FIG. 6. Therefore, the process of directly transferring the pattern of the pattern structure 110 of the mold 100 onto the flexible substrate 116 is completed.

Then, the exposed portion of the flexible substrate 116 is etched by using the portion 114b of the transfer material layer 114 transferred on the surface 118 of the flexible substrate 116 as a mask. Such as shown in FIG. 7, in the etching step, a portion of the exposed portion of the flexible substrate 116 is removed to further transfer the pattern of the micro/nano pattern structure 128 to the flexible substrate 116, so as to form a micro/nano three-dimensional structure 130 in the flexible substrate 116. The micro/nano three-dimensional structure 130 includes a plurality of convex portions 136 and a plurality of concave portions 134. In the present embodiment, the pattern of the micro/nano three-dimensional structure 130 is transferred from the micro/nano three-dimensional structure 128, so that the pattern of the micro/nano three-dimensional structure 130 is the same as the pattern of the micro/nano three-dimensional structure 128.

A dry etching method or a wet etching method may be used to etch the exposed portion of the flexible substrate 116. In one exemplary embodiment, a reactive ion etching method may be used to etch the flexible substrate 116, and an oxygen plasma may be used as an etchant, for example.

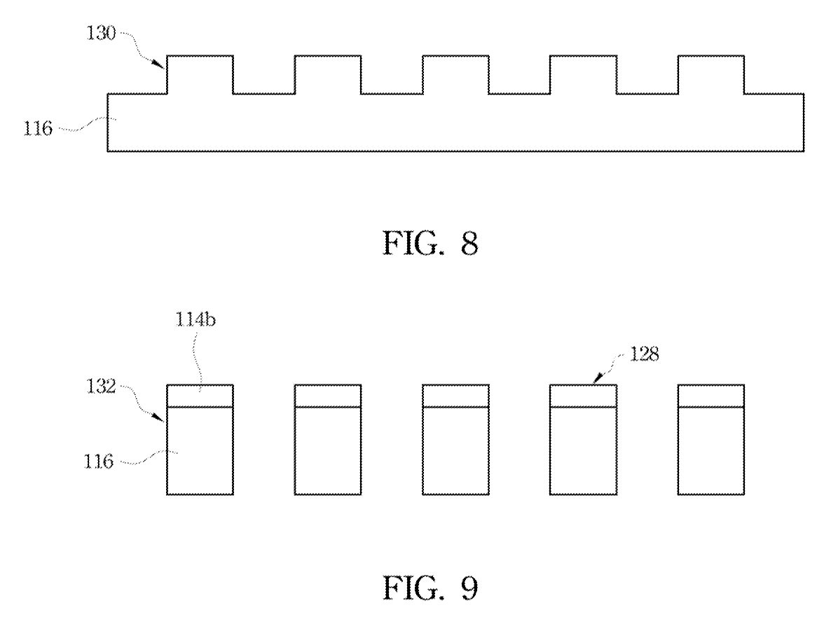

As shown in FIG. 8, in another embodiment, after the micro/nano three-dimensional structure 130 is formed in the flexible substrate 116, the portion 114b of the transfer material layer 114 may be removed.

As shown in FIG. 9, in still another embodiment, when the exposed portion of the flexible substrate 116 is etched by using the portion 114b of the transfer material layer 114 as a mask, the portion of the flexible substrate 116, which is not covered by the portion 114b of the transfer material layer 114, may be completely removed and the flexible substrate 116 is etched through to form a micro/nano three-dimensional structure 132.

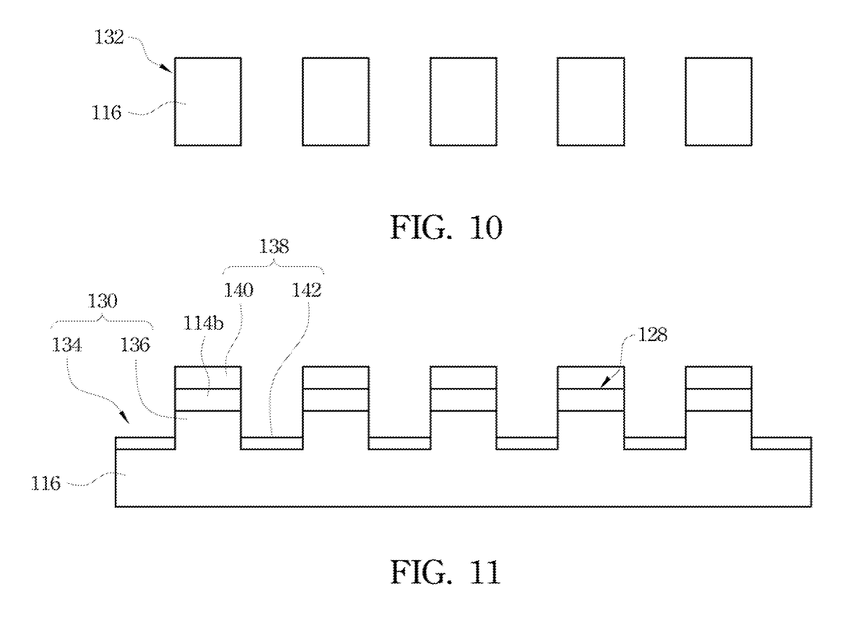

As shown in FIG. 10, in another embodiment, after the micro/nano three-dimensional structure 132 is formed in the flexible substrate 116, the portion 114b of the transfer material layer 114 may be removed.

In another embodiment, after the structure shown in FIG. 7 is formed, a mask layer 138 may be formed by, for example, an evaporation method. The mask layer 138 includes two portions 140 and 142. The portion 140 of the mask layer 138 is located on the portion 114b of the transfer material layer 114, and the other portion 142 of the mask layer 138 is located on the concave portions 134 of the micro/nano three-dimensional structure 130, such as shown in FIG. 11. The material of the mask layer 138 may be, for example, an inorganic material, a ceramic material, a metal material, a polymer-based material, an organic material, a plastic material, a semiconductor material or a compound composed of any combinations of the aforementioned materials.

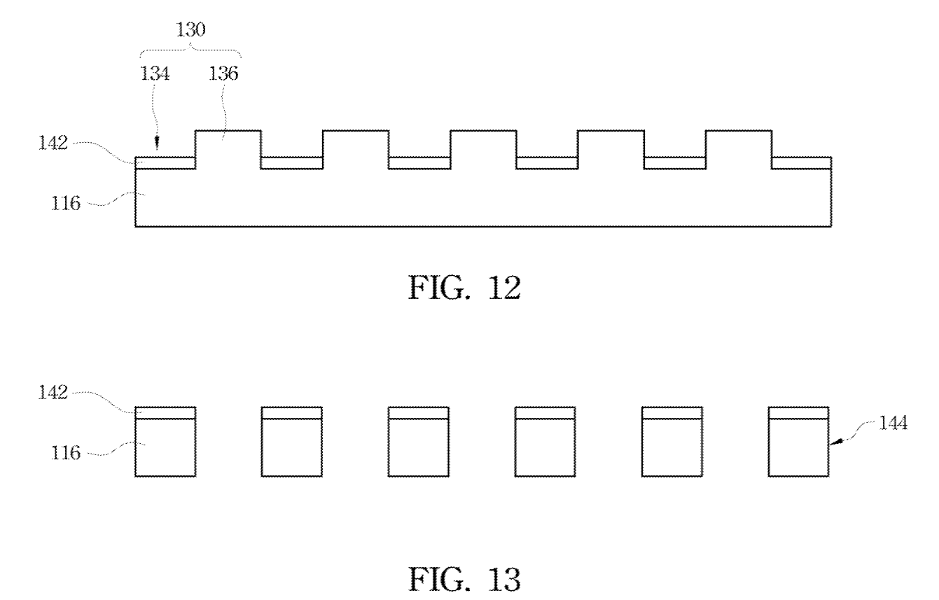

Then, the portion 140 of the mask layer 138 is removed through removing the portion 114b of the transfer material layer 114 by, for example, a lift-off method to expose the convex portions 136 of the micro/nano three-dimensional structure 130, such as shown in FIG. 12. In one embodiment, the material of the transfer material layer 114 is metal. Therefore, in the lift-off step, the materials of the transfer material layer 114 and the mask layer 138 are obviously different from the material of the flexible substrate 116, so that when the portion 114b of the transfer material layer 114 is etched away to lift-off the portion 140 of the mask layer 138, the flexible substrate 116 can be effectively prevented from being damaged by the etchant.

Subsequently, the portion 142 of the mask layer 138 on the concave portions 134 of the micro/nano three-dimensional structure 130 may be used as a mask to completely etch and remove the portion of the flexible substrate 116, which is not covered by the portion 142 of the mask layer 138, so as to form a micro/nano three-dimensional structure 144, such as shown in FIG. 13. The pattern of the micro/nano three-dimensional structure 144 is complementary to the pattern of the micro/nano three-dimensional structure 130.

In one embodiment, a dry etching method or a wet etching method may be used to etch the exposed portion of the flexible substrate 116. In one exemplary embodiment, a reactive ion etching method may be used to etch the flexible substrate 116, and an oxygen plasma may be used as an etchant, for example.

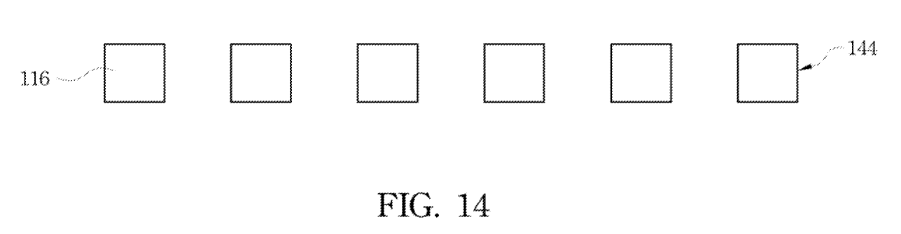

As shown in FIG. 14, in another embodiment, after the micro/nano three-dimensional structure 144 is formed in the flexible substrate 116, the portion 142 of the mask layer 138 may be removed.

According to the aforementioned embodiments of the present invention, one advantage of the present invention is that a method for manufacturing a micro/nano three-dimensional structure of the present invention can transfer a transfer layer including a micro/nano pattern onto a flexible substrate by a directly contact printing technique, and can use the transfer layer as a mask to etch the flexible substrate to successfully form a micro/nano three-dimensional structure on the flexible substrate.

According to the aforementioned embodiments of the present invention, another advantage of the present invention is that a method for manufacturing a micro/nano three-dimensional structure of the present invention can use a roll-printing method or a method of applying a uniform pressure to a mold to a flexible substrate, so that the problems of altitude difference and uniformity that may occur between the mold and a contact surface of the flexible substrate can be effectively solved, thereby increasing the reliability of the printing process. Therefore, the micro/nano pattern can be successfully transferred onto the flexible substrate by a printing process.

According to the aforementioned embodiments of the present invention, still another advantage of the present invention is that a method for manufacturing a micro/nano three-dimensional structure, which can successfully form another transfer layer in concave portions of a three-dimensional of a flexible substrate by lifting-off a transfer layer. Therefore, convex portions of the three-dimensional can be removed by using the another transfer layer as an etching mask, so that a micro/nano three-dimensional structure with a pattern complementary to a pattern of a mold can be successfully formed.

According to the aforementioned embodiments of the present invention, further another advantage of the present invention is that a method for manufacturing a micro/nano three-dimensional structure of the present invention can use a transfer layer transferred onto a flexible substrate as an etching mask to remove the portion, which is not covered by the transfer layer, to form a mask. The mask can be used as a mask in an electron beam lithography or a mask used to form a micro/nano pattern by a vapor deposition method.

According to the aforementioned embodiments of the present invention, yet another advantage of the present invention is that a method for manufacturing a micro/nano three-dimensional structure of the present invention performs a partially contacting and heating step on a flexible substrate, so that the thermal deformation of the flexible substrate due to the temperature can be effectively solved, and the micro/nano pattern can be successfully transferred onto the flexible substrate by a printing process.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for manufacturing a micro/nano three-dimensional structure, including:
providing a mold including a first surface and a second surface on opposite sides, and a pattern structure including a plurality of first convex portions and a plurality of first concave portions is set in the first surface of the mold;
forming a transfer material layer including a first portion on the first convex portions and a second portion on the first concave portions;
disposing a flexible substrate on the mold, wherein the flexible substrate includes a first surface and a second surface on opposite sides, and the first surface of the flexible substrate contacts with the first portion of the transfer material layer;
performing a heating step from the second surface of the mold to partially heat the flexible substrate through the first portion of the transfer material layer;
applying a pressure on the second surface of the flexible substrate to adhere the first portion of the transfer material layer to the first surface of the flexible substrate;
removing the mold; and
performing an etching step on the substrate by using the first portion of the transfer material layer to form a first micro/nano three-dimensional structure in the first surface of the flexible substrate.

2. The method for manufacturing a micro/nano three-dimensional structure according to claim 1, wherein the etching step completely removes a portion of the flexible substrate, which is not covered by the first portion.

3. The method for manufacturing a micro/nano three-dimensional structure according to claim 1, after the etching step, further including removing the first portion of the transfer material layer.

4. The method for manufacturing a micro/nano three-dimensional structure according to claim 1, after the etching step, further including:
forming a mask layer, wherein the mask layer includes a first portion on the first portion of the transfer material layer and a second portion on a plurality of concave portions of the first micro/nano three-dimensional structure;
performing a lift-off step to remove the first portion of the transfer material layer and the first portion of the mask layer; and
performing another etching step by using the second portion of the mask layer as a mask to remove the flexible substrate, which is not covered by the mask layer, to form a second micro/nano three-dimensional structure.

5. The method for manufacturing a micro/nano three-dimensional structure according to claim 4, wherein a material of the transfer material layer is an inorganic material, a ceramic material, a metal material, a polymer-based material, an organic material, a plastic material, a semiconductor material, or a compound composed of any combinations of the aforementioned materials.

6. The method for manufacturing a micro/nano three-dimensional structure according to claim 4, wherein a material of the mask layer is an inorganic material, a ceramic material, a metal material, a polymer-based material, an organic material, a plastic material, a semiconductor material or a compound composed of any combinations of the aforementioned materials.

7. The method for manufacturing a micro/nano three-dimensional structure according to claim 4, wherein a pattern of the second micro/nano three-dimensional structure is complementary to a pattern of the first micro/nano three-dimensional structure.

8. The method for manufacturing a micro/nano three-dimensional structure according to claim 4, after the another etching step, further including removing the first portion of the mask layer.

9. The method for manufacturing a micro/nano three-dimensional structure according to claim 4, wherein the another etching step is performed by using a dry etching method or a wet etching method.

10. The method for manufacturing a micro/nano three-dimensional structure according to claim 4, wherein the another etching step is performed by using a reactive ion etching method.

11. The method for manufacturing a micro/nano three-dimensional structure according to claim 10, wherein the another etching step is performed by using an oxygen plasma.

12. The method for manufacturing a micro/nano three-dimensional structure according to claim 1, wherein a material of the flexible substrate is an organic material, a plastic material, polymer, or a compound composed of any two or more of the aforementioned materials.

13. The method for manufacturing a micro/nano three-dimensional structure according to claim 1, wherein a material of the mold is silicon (Si), a polymer-based material, an organic material, a plastic material, a semiconductor material, a metal material, quartz, a glass material, a ceramic material, an inorganic material, or a compound composed of any two or more of the aforementioned materials.

14. The method for manufacturing a micro/nano three-dimensional structure according to claim 1, wherein the heating step uses a radiation heat source, a lamp-illuminating heat source, a thermal resistor heat source, an eddy current heat source, a microwave-heating heat source or an ultrasound-heating heat source.

15. The method for manufacturing a micro/nano three-dimensional structure according to claim 1, wherein the heating step includes heating a portion of the flexible substrate contacting with the transfer material layer to a glass transition temperature (Tg).

16. The method for manufacturing a micro/nano three-dimensional structure according to claim 1, wherein the heating step includes heating a portion of the flexible substrate contacting with the transfer material layer to a melting state.

17. The method for manufacturing a micro/nano three-dimensional structure according to claim 1, wherein the step of applying the pressure is performed by using a roller, and a material the roller is a transparent material or an opaque material.

18. The method for manufacturing a micro/nano three-dimensional structure according to claim 17, wherein a material of the roller is glass, metal, a plastic material, a polymer-based material, an inorganic material, a ceramic material, a semiconductor material, an organic material or a compound composed of any combinations of the aforementioned materials.

19. The method for manufacturing a micro/nano three-dimensional structure according to claim 1, wherein
a material of the mold is silicon;
a material of the flexible substrate is polyethylene terephthalate (PET); and
the heating step uses an infrared heat lamp.

20. The method for manufacturing a micro/nano three-dimensional structure according to claim 12, wherein a heating temperature of the heating step is between substantially 80° C. and substantially 300° C.

21. The method for manufacturing a micro/nano three-dimensional structure according to claim 1, wherein a material of the mold is ethylene tetrafluoroethylene.

22. The method for manufacturing a micro/nano three-dimensional structure according to claim 1, wherein a material of the mold is a fluorine-containing polymer-based material with an anti-stick effect.

23. The method for manufacturing a micro/nano three-dimensional structure according to claim 1, wherein a material of the mold is metal, an inorganic material, a polymer-based material, a ceramic material, a semiconductor material or an organic material with an anti-stick effect, or a compound composed of any two or more of the aforementioned materials.

24. The method for manufacturing a micro/nano three-dimensional structure according to claim 1, wherein the step of applying the pressure includes using a roller to perform a roll-printing step on the flexible substrate.

25. The method for manufacturing a micro/nano three-dimensional structure according to claim 1, wherein the step of applying the pressure includes applying a uniform pressure.

26. The method for manufacturing a micro/nano three-dimensional structure according to claim 1, before the step of forming the transfer material layer, further including forming an anti-stick layer on the first convex portions and the first concave portions.
